(19) United States
(12) Patent Application Publication
(10) Pub. No.: US 2015/0260901 A1
(43) Pub. Date: Sep. 17, 2015

(54) THIN AND EFFICIENT LIGHT GUIDE SYSTEM

(71) Applicant: KONINKLIJKE PHILIPS N.V., Eindhoven (NL)

(72) Inventors: Gabriel-Eugen Onac, Veldhoven (NL); Giovanni Cennini, Eindhoven (NL)

(21) Appl. No.: 14/433,680

(22) PCT Filed: Oct. 2, 2013
(86) PCT No.: PCT/IB2013/059065

§ 371 Date: Apr. 6, 2015

Related U.S. Application Data
(60) Provisional application No. 61/712,373, filed on Oct. 11, 2012.

(51) Int. Cl. F21V 8/00

(52) U.S. Cl. CPC G02B 6/0045; G02B 6/0073; G02B 6/0036

(57) ABSTRACT

The present invention is based on the idea of providing an illumination system with a light guide (10) reduces the risk of causing non-uniformity in the light emitted by illumination system. With a light-guide (10) that has a curve-shaped top surface such that incident light falls on the top surface (18) at an angle larger than the critical angle of the light-transmissive light guide, the risk of hard boundaries and hot spots appearing may be reduced.

### FIELD OF THE INVENTION

The present invention relates to the field of backlight, and more specifically to a light guide system.

### BACKGROUND OF THE INVENTION

The penetration of LEDs in the backlight market is progressing at a very fast pace. As an illustration of this fact, in 2011 the percentage of large area LCD-TV's equipped with LED backlight surpassed the ones equipped with CCFL (Cold Cathode Fluorescent Lamp). Furthermore LEDs are nowadays being introduced more and more in the general illumination segment. A light guide based architecture is highly desirable for spreading the light in all these application as it allows for very compact designs.

U.S. Pat. No. 7,909,496 proposes a system where point light sources in combination with a light guide element and light redirecting elements is combined into a system which can emit light across one or more extended surfaces of the light guide and may be designed to be able to emit light uniformly across the extended surfaces. The system comprises one or more light-emitting elements and a light guide in which are defined one or more voids.

### SUMMARY OF THE INVENTION

It is an object of the present invention to provide an illumination system that is thin and that provides a good lighting uniformity. This may be beneficial both from a cost perspective, since less material is needed and from a design perspective, since thinner designs are increasingly popular on the market for esthetical reasons.

This and other objects of the invention are achieved by means of an illuminations system having the features set forth in the independent claims. Embodiments of the invention are defined in the dependent claims.

According to a first aspect of the invention, this and other objects are achieved by an illumination system having:

a light-transmissive light guide having a top surface and a bottom surface arranged opposite to each other,

one or more light-emitting elements, each having at least one light source, and being arranged for emitting light into the light-transmissive light guide,

wherein the light-transmissive light guide has a constant angle curve formed in the top surface adjacent to each of the one or more light-emitting element, such that incident light from each of the adjacent light emitting elements falls on the top surface at an angle larger than the critical angle of the light-transmissive light guide, thereby reflecting the incident light back into the light-transmissive light guide.

The present invention is based on the idea of providing an illumination system with a light guide that reflects all light leaving a light-emitting element at least once, in order to prevent most of the emitted light to leave the light guide in proximity of the light-emitting element. This may reduce the risk of non-uniformity in the light emitted by illumination system. With a light-guide that has a top surface shaped such that all incident light falls on the top surface at an angle larger than the critical angle of the light-transmissive light guide, total inner reflection is achieved and consequently the risk of hard boundaries and hot spots appearing may be reduced. A reflection that takes place by means of a total internal reflection (TIR) mechanism is lossless. The light guide may then be arranged to spread the light uniformly out of the light guide system and thus a compact illumination system with high optical efficiency and a uniform illumination pattern is provided.

By the term “adjacent to” should, in the context of present specification, be understood that the constant angle curve is formed near the light-emitting element in one direction such that it may be positioned above, on top of, overlying or covering the light-emitting element. Thus, the term “adjacent light emitting element” is defined in an analogous way.

The effect of having the constant angle curve formed in the top surface may be that a minimum light guide thickness is ensured while all light emitted by the light-emitting element is captured inside the light guide. The constant angle curve may stop once the tangent to the curve is horizontal, or in other words parallel to the bottom surface. From that point on, the total inner reflection will be ensured by the flat top surface. The constant angle curve may extend in all directions, or in other words be rotationally symmetric, with its origin above or adjacent to the position where light is emitted from the light-emitting element. Minor deviation, such as ±5° in the incidence angle, of the constant angle curve is possible within the scope of the present invention.

Total internal reflection is an optical phenomenon that occurs when a ray of light strikes a medium boundary at an angle larger than a particular critical angle with respect to the normal to the surface. If the refractive index is lower on the other side of the boundary and the incident angle is greater than the critical angle, no light can pass through and all of the light is reflected. The critical angle is the angle of incidence above which the total internal reflection occurs.

The term “light-emitting element” is used to define any device that emits radiation in any region or combination of regions of the electromagnetic spectrum for example, the visible region, infrared and/or ultraviolet region, when activated e.g. by applying a potential difference across it or passing a current through it. Therefore a light-emitting element can have monochromatic, quasi-monochromatic, polychromatic or broadband spectral emission characteristics. Each light-emitting element has at least one light source. Examples of light sources include semiconductor, organic, or polymer/polymeric light-emitting diodes, optically pumped phosphor coated light-emitting diodes, optically pumped nano-crystal light-emitting diodes or any other similar devices as would be readily understood by a person skilled in the art. Furthermore, the term light-emitting element can be used to define a combination of the specific light source that emits the radiation in combination with a housing or package within which the specific light source or light sources are placed.

A light guide is a transparent or translucent element which is configured to guide a flow of light through the light guide by internal reflection of the light. The outer sheath of the light guide, or parts of it, can be highly reflective and manufactured from aluminium, protectively coated aluminium, reflectively coated plastic material, a multilayer plastic reflective material for example 3M Vicuity™ foil, or the like, as would be readily understood by a person skilled in the art.

According to an embodiment of the present invention, the one or more light-emitting elements are in optical contact with the light-transmissive light guide.

By the term “optical contact” should, in the context of present specification, be understood that the high refraction medium of the light guide comes in direct contact with the optics of the light-emitting elements, or in other words no air gap exists between these two components. In this way light transfer from the light-emitting elements to the light guide will not suffer from Fresnel reflection, or at least suffer less, depending on the refraction indexes of the optics of the light-emitting element and the light guide.

In one embodiment of the present invention, each of the one or more light-emitting elements is positioned such that it emits light within a center of the constant angle curve. In other words, each of the one or more light-emitting elements is positioned such that a central point of the light-emitting element corresponds to a central axis of the adjacent constant angle curve. This arrangement may simplify the forming of the constant angle curve since known formulas may be used, as explained later in this application.

In a further embodiment of the present invention, the one or more light-emitting elements are arranged to emit light into to the light-transmissive light guide via the bottom surface. The light-emitting elements may also be arranged to emit light into the light guide via a side surface or any other suitable surface. The light-emitting elements may be glued to the suitable surface or inserted into the light guide at the suitable surface, preferably in optical contact therewith. In one embodiment the light-emitting elements are arranged at the bottom surface of the light guide and emitting light towards the opposed surface, i.e. the top surface.

In yet another embodiment of the present invention, the one or more light-emitting elements may be provided in a cavity of the bottom surface. This may be advantageous when manufacturing the illumination system; the light-emitting elements may then be easily inserted in the light guide. The cavity may have a square profile or a semicircular profile. Other profiles are equally possible. The cavity may or may not have reflecting surfaces or its surface may be part reflective and part not reflective.

In a one embodiment of the present invention, the at least one light source is a top-emitting LED. In a further embodiment, the at least one light source is a side-emitting LED. There may also be a case where the light sources of an illumination system include different types of light sources, for example one or several top-emitting LEDs mixed with one or several side-emitting LEDs. Other suitable types of light sources are equally possible. Side emitters arranged in a matrix may be used to inject light into small light guide tiles in order to spread and mix the light in the illumination system. It may be noted that LEDs may offer significantly better power efficiency compared to other light sources such as CCFL- or HCFL-sources. The number of LEDs in the illumination system of the present invention may depend on the whished illumination level and the light flux per LED.

According to another embodiment of the present invention, at least one of the one or more light-emitting elements has at least two light sources and a mixing cavity which is arranged in the light-transmissive light guide and has a reflecting top surface. The reflecting top surface of the mixing cavity may have the effect that the light emitted from the light sources in the mixing cavity enters the light guide at predetermined positions; thereby it may be easier to achieve total inner reflection. The effect of letting the light of several light sources mix before entering the light guide may be that each light-emitting element may emit a more uniform light with regards to color and intensity. The mixing cavity may advantageously have a square profile but any other suitable shapes, such as a trapezoid profile, are equally possible.

According to a further embodiment of the present invention, at least a part of the reflecting top surface of the mixing cavity is a mirror. According to yet another embodiment of the present invention at least a part of the reflecting top surface of the mixing cavity is a diffuse reflector. Diffuse reflection is the reflection of light from a surface such that an incident ray is reflected at many angles rather than at just one angle, as in the case of specular reflection, i.e. reflection as in a mirror. The diffuse reflector may thus be advantageous for mixing purposes.

According to an embodiment of the present invention, the illumination system may further have extraction elements positioned in the light-transmissive light guide for extracting light out of the light-transmissive light guide. The extraction elements may both redirect and scatter the light that falls on them. The extraction elements can take a wide variety of shapes, sizes and distributions. They may be of equal size or they may differ in size, for example the size of the extraction elements may increase towards the edges of the illumination system. They may be coated with a reflective coating. They may be molded or glued to the bottom surface or to any other suitable surface.

According to another embodiment of the present invention, the extraction elements may be either or both of an array of white paint dots, an array of prisms, an array of roughened dots on the surface of the light guide or an array of scattering particles or voids inside the light guide. The extraction element may further be provided in the form of a random roughness of a surface achieved by etching or sandblasting for pits in the surface. The distribution and type of extraction elements may be chosen to increase the light mixing and/or brightness uniformity of the illumination system. In one embodiment, the extraction pattern is arranged at the bottom surface of the light guide. In further embodiment the extraction elements may be arranged on the top surface or inside the light guide. As an alternative, wedge shaped light guides may be used to extract the light.

According to an embodiment of the present invention, the extraction elements are designed such that light from one of the one or more light-emitting elements is extracted from the light-transmissive light guide in an area adjacent to the light-emitting element such that local control of a luminance is possible. This may have the advantage that 2D-dimming may be achieved as described below. The extraction elements may also be designed such that a uniform illumination pattern from the illumination system is achieved.

In yet another embodiment of the present invention, the light-transmissive light guide is a polymethylmethacrylate (PMMA) plate. Other material such as acrylic resin, polycarbonate, epoxies, and glass are equally possible materials.

In a second aspect, the present invention provides an illumination device comprising an illumination system according to the first aspect of the present invention. In one embodiment of the present aspect, the illumination device is a liquid crystal display television.

The second aspect may generally have the same features and advantages as the first aspect.

It is noted that the invention relates to all possible combinations of features recited in the claims. Generally, all terms used in the claims are to be interpreted according to their ordinary meaning in the technical field unless explicitly defined otherwise herein.

Other objectives, features and advantages of the present invention will appear from the following detailed disclosure as well as from the drawings.

### BRIEF DESCRIPTION OF THE DRAWINGS

This and other aspects of the present invention will now be described in more detail, with reference to the appended drawings showing embodiment(s) of the invention.

FIGS. 1a and 1b illustrate a schematic side view of a conventional illumination system;

FIGS. 2a and 2b illustrate a perspective view and a schematic side view, respectively, of a light guide according to embodiments;

FIGS. 3a and 3b schematically illustrate a side view of an illumination system according to embodiments;

FIG. 4 illustrates a schematic side view of a light guide and a light-emitting element according to embodiments;

FIGS. 5a and 5b schematically illustrates illumination systems according to embodiments.

As illustrated in the figures, the sizes of layers and regions are exaggerated for illustrative purposes and, thus, are provided to illustrate the general structures of embodiments of the present invention. Like reference numerals refer to like elements throughout.

### DETAILED DESCRIPTION

The present invention will now be described more fully hereinafter with reference to the accompanying drawings, in which currently preferred embodiments of the invention are shown. This invention may, however, be embodied in many different forms and should not be construed as limited to the embodiments set forth herein; rather, these embodiments are provided for thoroughness and completeness, and fully convey the scope of the invention to the skilled person.

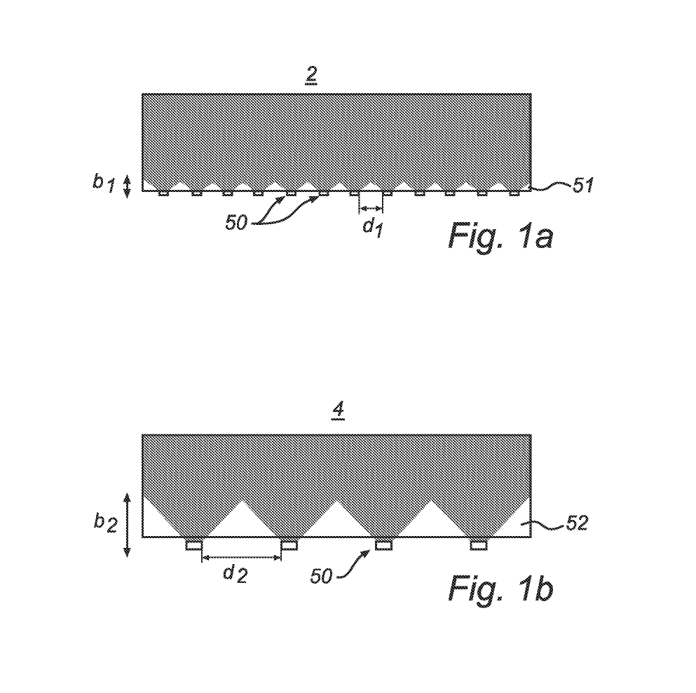

As LEDs are becoming more and more efficient and the demand for lower cost systems increases, the amount of installed LEDs in a backlight unit, for a given front of screen performance (FOS) decreases. As a consequence, the pitch of the LEDs increases and thus the bezel of the backlight system will increase to ensure good backlight uniformity, as clearly shown in FIGS. 1a and 1b and described below. Bezel is the outside edges of the backlight system and its size depends on the thickness of the light guide. Depending on the size of the backlight system, light transport through the light guide leads to light absorption and therefore lower system efficiency.

Operation of a conventional illumination system will now be disclosed with reference to an illumination system 2 and 4 and light-emitting elements 50 of FIG. 1a and FIG. 1b. In illumination system 2, the light-emitting elements, e.g. LEDs, 50 are placed at the edges of the light guide 51. The bezel b₁ is rather small in this system due to the fact that many low brightness LEDs are used. Given a certain LED pitch d, i.e. distance between two consecutive LEDs, the minimum bezel b for good color mixing in the light guide is of the order of

$$b = \frac{d}{2 \cdot tan ( {θ}_{C} )}$$

in which θ_{C} represents the critical angle which depends on the refractive index of the light guide 52,

As LEDs are becoming more and more efficient the amount of installed LEDs 50 for a given illumination performance of the illumination system 4 decreases. As a consequence, the pitch d₂ of the LEDs increases and also the bezel b₂ of the illumination system 4 will increase, see FIG. 1b. From the design point of view such an increase is not acceptable. Furthermore the bezel b2 increases the length of the light transport through the light guide 52, e.g. the light path, for each light ray emitted by the light-emitting element 50. A consequence of this is that more light is absorbed by the light guide 52 and this leads to lower system efficiency.

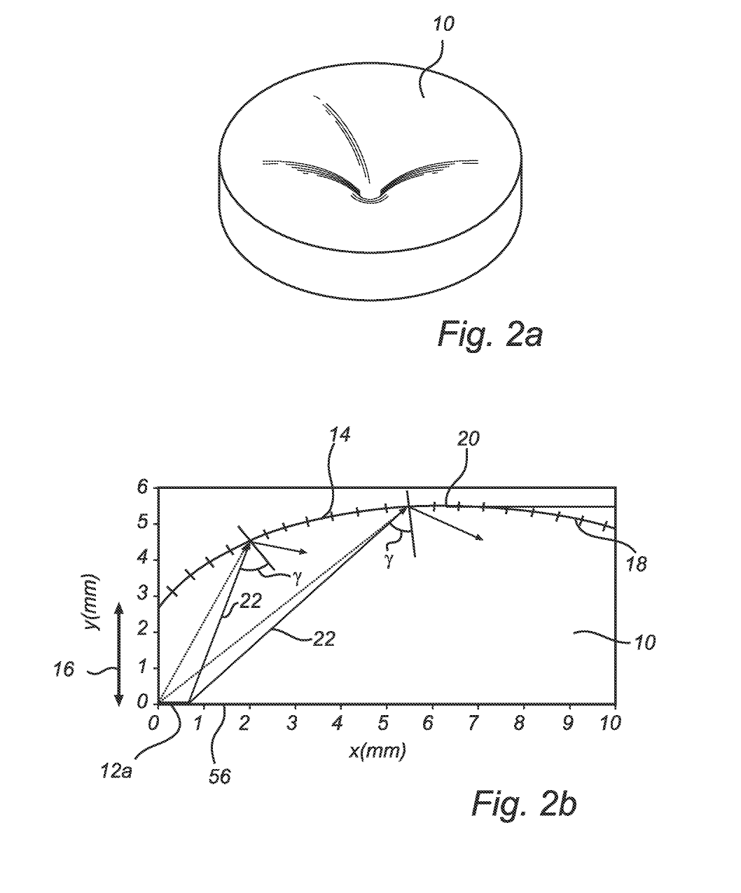

The present invention aims at solving the problem with the prior art illumination systems shown in FIGS. 1a and 1b by providing a specially designed light guide. The light guide is constructed such that it bends the light from the light-emitting elements inside the light guide and at the same time provides mixing and spreading of light, all in a thin design and with a high optical efficiency. A perspective view of an exemplary embodiment of the light guide 10 is shown in FIG. 2a.

FIG. 2b shows a schematic side view of the light guide 10 in FIG. 2a. The light-emitting element 12a is placed directly beneath the center of the light guide 10. For explanatory purposes, only the right side of the light guide 10 is shown in FIG. 2b and thus only the right side of the light-emitting element 12a is shown. The bottom surface 56 of the light guide 10 is in optical contact with the light-emitting element 12a. This ensures a higher system efficiency. The top surface 14 of the light guide 10 is tailored in such a way that any ray emitted by the light-emitting element falls at the light guide—air interface at an angle γ larger than the critical angle of the material of the light guide, with respect to the surface normal, as shown in FIG. 2b. This results in total internal reflection (TIR) of the light inside the guide. The shape of the light guide 10 resembles a constant angle (CA) profile 18. The top surface 14 of the light guide 10 can be directed to an LCD display (not shown).

In FIG. 2b, the working principle of a constant angle curve is depicted. The constant angle shape ensures a minimum light guide thickness while at the same time allowing capture of all light emitted by the light-emitting element 12a inside the light guide. The minimum distance 16 from the light-emitting element and the surface of the light guide is shown as a reference. The CA curve 18 can stop once the tangent to the curve is parallel 20 to the bottom surface 56, which is shown for explanatory purposes. From that point on the TIR will be ensured by the flat top surface. The rays 22 which are emitted by the outer edge of the light-emitting element 12a form the steepest angles with the material-air interface, in other words the top surface 14. The CA curve is designed such that these rays form a constant angle γ with the normal to the material-air interface.

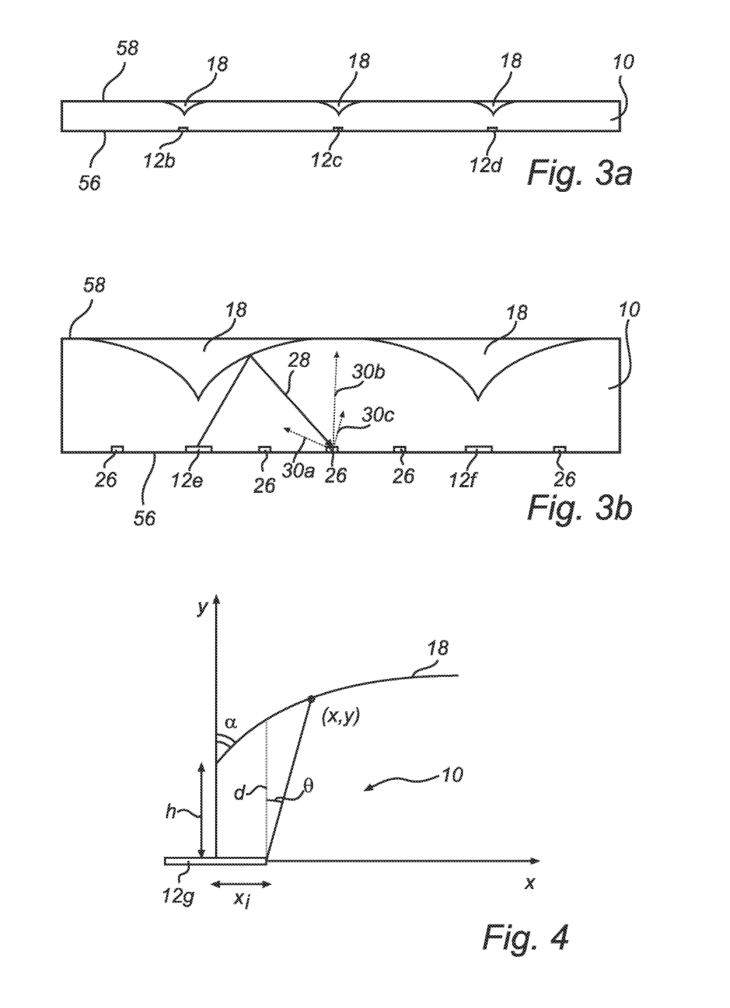

In FIG. 3a, an embodiment of the light guide 10 with several top emitting light elements 12b-12d in optical contact with the light guide 10 is shown. The top emitting light elements 12b-12d are positioned at the bottom surface 56 of the light guide 10. The light guide in this embodiment is few millimeter thick. CA structures 18 are engraved on the top surface 58 of the light guide.

FIG. 3b illustrates redirection and extraction of light from top emitter light elements 12e-12f. The curve 18 provided at the top surface 58 of the light guide 10 on top of each LED can be tailored such that the rays 28 form the light elements 12e-12f are TIR-ed inside the light guide. Extraction elements 26, which may be in the form of white paint dots or an array of prisms are provided at the bottom surface 56 of the light guide 10 and are used for altering the propagation of light through the light guide and thus to scatter the light out of the light guide as is shown by dashed lines 30a-30c.

The extraction pattern can be designed such that light from one light element is extracted in an area close to the light element in a uniform illumination pattern. The fact that LEDs can easily be arranged in a 2D array and individually controlled makes it possible to perform 2D, i.e. horizontal and vertical, dimming, something that is not possible with conventional CCFL or HCFL lamps. When using the illumination system as a backlight for a LCD-screen, this allows the backlight to locally produce more light behind bright areas of the displayed picture and less light behind dark areas of the displayed picture. This ensures a better image quality, e.g. in terms of improved contrast and better motion portrayal, at a lower energy usage.

The illumination system may further include additional light redirection elements, such as elements having a diffuse or specular reflective perimeter surface, or elements coated with one or more layers capable of diffuse or specular reflection for light within a desired wavelength regime. These light redirecting elements may be spherical, or have other shapes and may have an index of refraction different from that of the main material of the light guide.

Ray-tracing simulation based on the geometry in FIG. 3a and FIG. 3b shows that the luminance distribution from the light guide with the inventive CA structures has a relatively good uniformity. The simulations refer to the simple case of a 4 mm thin light guide in combination with a back reflector. The uniformity improves when thicker light guides are considered. Furthermore standard optical management foils can be used to further improve the uniformity, for example diffuser films, brightness enhancement foils (BEF, DBEF), anti-reflection and anti-glare films, heat (IR) rejecting films, conductive coatings to minimize atmospheric disturbance and anti-fog films can be used. The illumination system presented in this document and exemplified in FIGS. 3a and 3b may advantageously be used in many areas of application, such as for instance as a lamp or backlight for an LCD monitor or television.

The structure of an exemplary embodiment of a constant angle structure will now be disclosed with reference to FIG. 4. In this embodiment, a top emitting LED is used as light-emitting element 12g. The light guide 10 has a constant angle structure 18 on its top side. With reference to FIG. 4, the equations that describe the CA curve are:

x=de^{θ tan θ}^{_{cr}} sin θ+xᵢ

y=de^{θ tan θ}^{_{cr}} cos θ

The distance d is:

$$d = \frac{h}{{e}^{( {θ}_{cr} + α - \frac{π}{2} ) tan {θ}_{cr}} cos ( {θ}_{cr} + α - \frac{π}{2} )}$$

in which

θ_{cr} denotes the critical angle of the light guide material,

xᵢ denotes the distance between the center and the outer edge of the light-emitting element 12g,

θ denotes the angle between a line perpendicular to the light-emitting element 12g, e.g. d, and a ray of light emitted by the light-emitting element,

α denotes the initial angle of the CA structure 18 in relation to line perpendicular to the light-emitting element that passes through the center of the rotationally symmetric CA structure 18,
h denotes the minimum distance from the light-emitting element 12g and the surface of the CA structure 18,
x and y denotes the position where a ray of light falls on the CA structure 18, relative to the centre of the light emitting element.

The CA curve can also be described using the functional form:

ƒ(x)=P₀+P₁x+P₂x²+P₃x³+P₄x⁴+P₅x⁵

wherein P₁, P₂, P₃, P₄ and P₅ represent respective polynomial coefficients and x represents the distance from the origin.

The above formula applies to rotationally symmetric systems with the LED placed at the origin x=0. Note that the table below, where the values of the coefficients of the polynomial expression are given, refers to a case in which millimeters are used as length units. Moreover, the coefficients have been calculated for the case where the LED size is 1×1 mm². This makes the expression scalable to smaller or larger LED sizes x, as long as x is substituted with αx, where α is the scaling factor.

| | CAC (43°) | CAC (45°) | CAC (50°) |
|---|---|---|---|
| P5 | 0.0016793035992890 | 0.0010900780003410 | 0.000264404714058 |
| P4 | −0.0278514935287240 | −0.0200882524561710 | −0.006901451100336 |
| P3 | 0.1827453388708680 | 0.1466147921179770 | 0.071465289893044 |
| P2 | −0.6781369744390800 | −0.6037765119250810 | −0.415023019213015 |
| P1 | 1.6863009313836600 | 1.6943603603280800 | 1.705389546746150 |
| P0 | 1.7872658414943200 | 1.9833836836022000 | 2.695096439490840 |

In the above table, CA coefficients for three types of CA optics are shown. The coefficient is calculated by using a LED with an area of 1×1 mm². CAC is an abbreviation for constant angle curve. The desired angle depends on the critical angle of the material used in the light guide. For example, if we want to use an LED with an emitting surface of 1×1 mm², we can calculate that for a CA with an angle of 43°, the distance between the LED and the flat surface of the CA must be 4 mm. Instead, if we use a smaller LED, for example Starburst LEDs, with an emitting area of 0.68×0.68 mm², the total height of the CA and, hence, the total thickness of the light guide is about 2.8 mm.

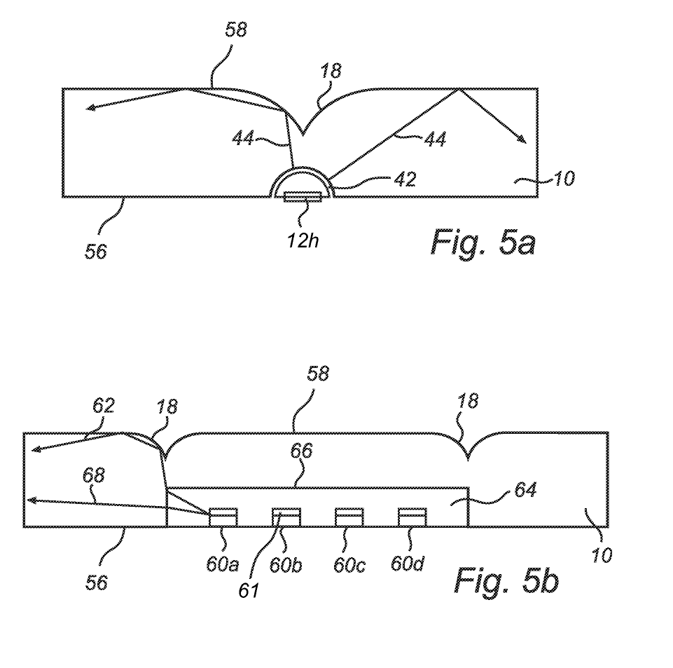

FIG. 5a is an example of yet another embodiment of the present invention. In this embodiment, the light-emitting element 12e is a top emitting LED placed inside a coupling hole 42 in the light guide 10. In this example, the coupling hole 42 has a semicircular cross-section profile, but any other suitable cross-section profiles, such as a square profile, a cylindrical profile, a rectangular profile, a trapezoidal profile and the like, could be used. The top emitting LED may be a Lumiled Rebel LED manufactured by Philips. Above the LED a CA shape is engraved in the light guide. The CA shape is used for redirecting the LED light 44 that would normally escape in the case of a flat top surface of the light guide. Light emitted side-wards is already light guided in the light guide 10 (e.g. PMMA plate), while the top emitted part is redirected by the CA structure 18 and afterwards light guided. In an embodiment the CA structures 18 at the top surface 58 of the light guide 10 can be positioned such that a central axis of the CA structure 18 is rotationally symmetric positioned with respect to a center of a light emitting area of the light-emitting element 12e.

FIG. 5b illustrates an embodiment of the present invention where side-emitting LEDs are used as the light-emitting elements 60a-60d. The LEDs are placed inside a mixing cavity 64. A mirror or a diffuse reflector 66 on top of the mixing cavity 64 prevents light from leaking upwards. At the edge of the cavity the CA engraved structures 18 redirect the top scattered light 62 back in a lateral direction of the light guide 10 and thereby guiding of this light inside the light guide 10 is accomplished. The light guide 10 may be provided in the form of a PMMA plate. Light emitted side-wards 68 is already light guided in the light guide 10. This embodiment is well suited for LED count reduction. When LEDs become more efficient the geometry remains the same, while the number of LEDs installed in the mixing cavity is decreased.

Further, this embodiment is robust against intensity or color point differences between individual LEDs. If the reflecting material on the top surface of the mixing cavity is very thin some light may leak through it. The critical thickness depends on the reflecting material used and can range from tens of microns to millimeters. In order to prevent such leakage to be seen as a light spot on the surface of the light guide, the top surface of the mixing cavity may have light scattering features which may be achieved by molding in small prisms or roughening the surface. Thereby, any upward light from the light sources through the reflecting surface of the mixing cavity will be spread out and not be noticeable. All the above embodiments of the light guides may be used to backlight an LCD display or for general purpose lighting where a thin lighting source is desirable.

The person skilled in the art realizes that the present invention by no means is limited to the preferred embodiments described above. On the contrary, many modifications and variations are possible within the scope of the appended claims. For example, a light guide, as exemplified in the figures above, can be made of a material being solid-rigid, solid-flexible or combinations thereof as long as the material is transparent. Examples of these materials can include glass, plastic, Plexiglas, acrylic, PMMA or other similar light transmissive material or any combinations thereof as would be known to a person skilled in the art.

Additionally, variations to the disclosed embodiments can be understood and effected by the skilled person in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measured cannot be used to advantage.

1. An illumination system having:
a light-transmissive light guide having a top surface and a bottom surface arranged opposite to each other,
one or more light-emitting elements, each having at least one light source, and being arranged for emitting light into the light-transmissive light guide,
wherein the light-transmissive light guide has a constant angle curve formed in the top surface adjacent to each of the one or more light-emitting elements, such that incident light from each of the adjacent light emitting elements falls on the top surface at an angle (γ) larger than the critical angle of the light-transmissive light guide, thereby reflecting the incident light back into the light-transmissive light guide,
further having extraction elements positioned in the light-transmissive light guide for extracting light out of the light-transmissive light guide.

2. The illumination system according to claim 1, wherein the one or more light-emitting elements are in optical contact with the light-transmissive light guide.

3. The illumination system according to claim 1, wherein each of the one or more light-emitting elements is positioned such that a central point of the light-emitting element corresponds to a central axis of the adjacent constant angle curve.

4. The illumination system according to claim 1, wherein the one or more light-emitting elements are arranged to emit light into to the light-transmissive light guide via the bottom surface.

5. The illumination system according to claim 1, wherein the one or more light-emitting elements are provided in a cavity of the bottom surface.

6. The illumination system according to claim 5, wherein the cavity has one of: a square profile and a semicircular profile.

7. The illumination system according to claim 1, wherein the at least one light source is a top-emitting LED.

8. The illumination system according to claim 1, wherein the at least one light source is a side-emitting LED.

9. The illumination system according to claim 1, wherein at least one of the one or more light-emitting elements has at least two light sources and a mixing cavity which is arranged in the light-transmissive light guide and has a reflecting top surface.

10. The illumination system according to claim 9, wherein at least a part of the reflecting top surface is at least one of: a mirror, a diffuse reflector.

11. (canceled)

12. The illumination system according to claim 1, wherein the extraction elements are at least one of: an array of white paint dots, an array of prisms, an array of roughened surface dots.

13. The illumination system according to claim 1, wherein the extraction elements are designed such that light from one of the one or more light-emitting elements is extracted from the light-transmissive light guide in a uniform illumination pattern.

14. The illumination system according to claim 1, wherein the extraction elements are designed such that light from one of the one or more light-emitting elements is extracted from the light-transmissive light guide in an area adjacent to the light-emitting element such that local control of a luminance is possible.

15. An illumination device comprising an illumination system according to claim 1.
